(19) United States
(12) Patent Application Publication
(10) Pub. No.: US 2013/0159070 A1
(43) Pub. Date: Jun. 20, 2013

(54) MOBILE PAYMENT PROCESSING SYSTEM

(71) Applicant: Michael L. Salamone, Cheshire, CT (US)

(72) Inventor: Michael L. Salamone, Cheshire, CT (US)

(21) Appl. No.: 13/710,712

(22) Filed: Dec. 11, 2012

Related U.S. Application Data
(60) Provisional application No. 61/570,978, filed on Dec. 15, 2011.

(51) Int. Cl. G06Q 50/30; G06Q 20/32

(52) U.S. Cl. CPC G06Q 50/30; G06Q 20/32
USPC 705/13

(57) ABSTRACT

The mobile payment processing system is an electronic ordering, payment, and inventory management system relating to parking stall purchases and other types of activities and transactions, such as event/ticket purchases. The system can be cell-phone or smart phone based and web based and may be operated from a central hosting system. Individual users and merchants would monitor their respective transactions and associated accounts. Operators of parking facilities and municipalities would be able to review their respective revenue utilizing protected access to a web-based site.

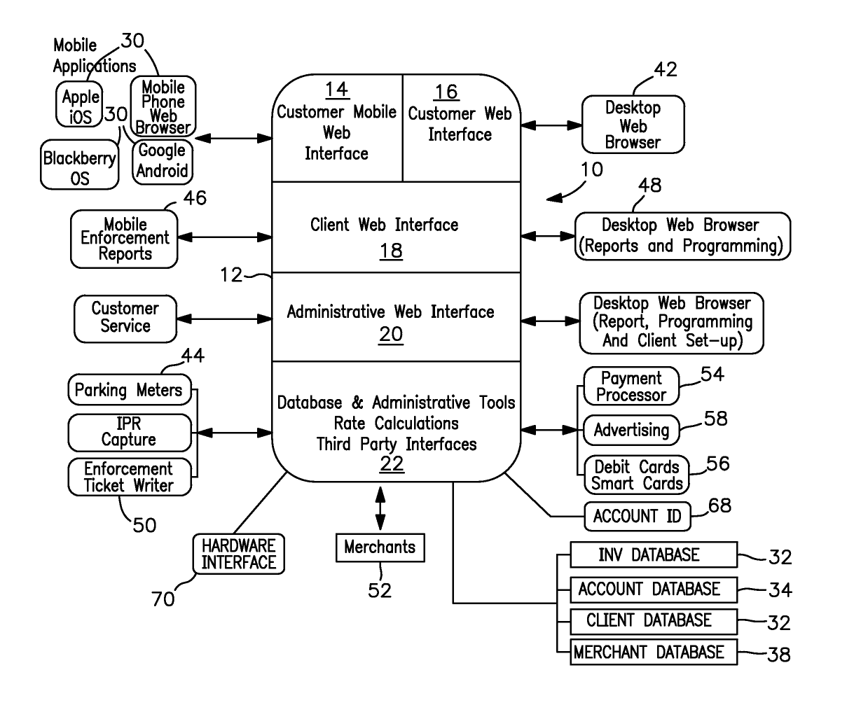

### CROSS REFERENCE TO RELATED APPLICATION(S)

The instant application claims the benefit of U.S. Provisional Patent Application No. 61/570,978, filed Dec. 15, 2011, entitled MOBILE PAYMENT PROCESSING SYSTEM.

### BACKGROUND

The present disclosure relates to a mobile payment processing system (MPPS) and process which may be used by municipalities and others such as municipal and federal parking authorities/operators and merchants to process and track transactions involving parking and other transactions.

Progress in technology has resulted in the development of numerous options, equipment and associated methods for collecting parking fees. These include smart meters, multi-space meters (pay by space, pay by plate), pay by cell, license plate recognition, and prepaid ID recognition. While these advancements in technology have resulted in various equipment options and features in parking payment and revenue collection, several short-falls exist. These include the following: (1) fragmented systems which warrant monitoring by utilizing various monthly services from the manufacturers; pay by cell by third party providers which add to the revenue collection coordination efforts; equipment limitations for variable event/time parking rates in special dedicated zones; extensive violation enforcement and ticket writing efforts due to the fragmented systems; costly monthly fees associated with the various parking patron payment options; lack of integration between space sensing devices, with systems on the market and associated parking management software; and lack of integration with older equipment and protocol which exists and varies between a client's various facilities.

While there are various systems available, the current products, equipment and related software that exists in the market is fragmented relative to the services they perform respectively.

### SUMMARY

In accordance with the present disclosure, there is provided a system which fully integrates the pay by cell, parking stall inventory management and compilation of existing hardware system outputs into the system. The system becomes the front end compiler of data from a revenue perspective, inventory/space availability, as well as allowing for integration of existing equipment operations. The system allows for a search per zone/parking stall for any parking facility that subscribes. The search may be accomplished by address/zip code.

The system may be enhanced to utilize GPS features relating to locating facilities, as well as incorporating near frequency range (NFR) technology.

The system also allows for other transactions via mobile based applications. These transactions may include, but are not limited to, promotional activities, direct market advertisement which would target the parking patrons on a zone specific basis, purchase of concerts/events tickets and functions, purchases of products and services, and messaging.

The system also provides for transaction validations whereby a validation code is scanned, and the active parking session can be credited back to the user and charged to a merchant account.

In accordance with the present invention, there is provided a system which broadly comprises a central host having an inventory database containing information about an inventory of parking spaces; said central host having an account database containing a plurality of user accounts; and accessing means for allowing a user to access said inventory database to locate an available parking space and pay for same using his/her user account.

In another and alternative embodiment, the accessing means comprises a mobile device.

In another and alternative embodiment, the mobile device comprises one of a smartphone, a tablet device, and a PDA.

In another and alternative embodiment, the mobile device includes an application for receiving a receipt for said parking space and for displaying a coded symbol for gaining access to an automated parking facility.

In another and alternative embodiment, the system further comprises means for a client to access said central host to receive a periodic report on parking fees collected from said users and means for electronically transferring said collected fees to an account belonging to said client.

In another and alternative embodiment, the client access means comprises a client interface for issuing reports to said client and for providing real time information to said client about parking space usage.

In another and alternative embodiment, the system further comprises means for each user to access his/her account so as to add funds to the account and make purchases of goods and services.

In another and alternative embodiment, the account access means comprises a browser.

In another and alternative embodiment, the system further comprises said central host having a merchant database containing information about a plurality of merchants and items being offered for sale by said merchants.

In another and alternative embodiment, the merchant database contains a plurality of merchant accounts.

In another and alternative embodiment, the central host comprises a pre-programmed processor.

In another and alternative embodiment, the system further comprises means for providing law enforcement officials with information about parking violations in real-time.

In another and alternative embodiment, the system further comprises means for sending at least one of messages, advertisements, and promotions to users of the system.

In another and alternative embodiment, the accessing means comprises means for allowing a user to prepay for a parking space for a period of time.

Further in accordance with the present disclosure, there is provided a process which broadly comprises the steps of opening a parking app on an accessing device; pushing a start parking button on said parking app; pushing a start parking now button when a parking location has been located; showing an amount that will be charged on a screen on said accessing device; and pushing a stop parking now button on said accessing device when the parking location is to be left.

In another and alternative embodiment, the process further comprises entering information comprising at least one of a license plate number, a parking zone number, and a parking spot number using said accessing device after pushing said start parking button.

In another and alternative embodiment, the process further comprises displaying a rate on said accessing device after entering said information.

In another and alternative embodiment, the process further comprises verifying a stop parking instruction.

In another and alternative embodiment, the process further comprises debiting a user account with said amount that will be charged.

In another and alternative embodiment, the process further comprises prompting a user as to when a parking transaction is about to expire and inquiring whether the user would like to add time to the parking transaction.

Other details of the mobile payment processing system and process of the present invention are set forth in the following detailed description and the accompanying drawing wherein like reference numerals depict like elements.

### BRIEF DESCRIPTION OF THE DRAWINGS

The FIGURE is a schematic representation of a mobile payment processing system;

### DETAILED DESCRIPTION

The system of the present disclosure is an electronic ordering, payment, and inventory management system relating to parking stall purchases. The system may be cell-phone or smartphone based and web based and may be operated from a central hosting system. Individual users may monitor their respective transactions and associated accounts. Operators of parking facilities and municipalities who operate parking facilities (the clients) may review their respective revenue utilizing protected access to a web-based site. Subscribing merchants can also have an account to reimburse/validate transactions.

The FIGURE illustrates a schematic representation of the system 10. The system 10 may be implemented using any suitable pre-programmed processor 12 known in the art. The processor 12 is programmed to carry out the various functions described herein. As can be seen from the FIGURE, the system may have a customer mobile web interface 14 for use with a variety of mobile devices, a separate customer web interface 16 for interfacing with web browsers, a client web interface 18 for issuing reports such as mobile enforcement reports, an administrative web interface 20 for issuing reports, performing client set-up operations, and performing customer service; and a database and administrative interface 22 which supports third party interfaces.

As shown in the FIGURE, the system 10 may have a number of databases associated with it. The databases may include an inventory database 32 which contains information about an inventory of parking spaces and parking locations in a particular zone or region; an account database 34 which contains a plurality of customer/user accounts; a client database 36 containing information about a plurality of client accounts; and a merchant database 38 containing information about a plurality of merchant accounts, information about the merchants, and information about goods and services being offered for sale by the merchants.

The system 10 described herein may be operated on an IT platform that supports Internet websites, mobile web, and smart phone applications (Apps). Using a real-time database, payment transactions may be implemented via mobile devices 30 and/or web applications 42. Customers may pay for parking by logging into a registered account contained in the account database 34 that they created via the Internet web 42, a mobile web 30, or an App downloaded from a smart phone. An initial registration is required and, once established, transactions can take place using the monies in the customer account. Customers no longer have to leave their car to pay an attendant or fill a meter on the side of a road. For example, by tapping a button displayed on the customer's cell phone 30, parking time can be extended from any location.

As part of each customer's account, an electronic wallet is created. The wallet may be funded through a third-party credit/debit card processor 56, e.g. Pay-Pal, authorized payment services, etc. The customer's electronic wallet is debited with each parking and/or related transaction. Based on the activity and credit level, the electronic wallet may be automatically up-funded as necessary to maintain a minimum balance. The customer may log into his/her respective account using any suitable accessing device 42, such as a desk top web browser, and the customer web interface 16 to review the activity in their account and/or to add funds to the account to be used to pay for parking and the purchase of goods and services.

The system 10 would also enable a customer or end-user to locate a subscribing facility in the immediate area from his/her mobile device using a zip code search and/or cell phone GPS. Parking transactions may also be done using a mobile site.

To start a parking session, a customer or user may perform the following sequence using their mobile accessing device 30, such as a smartphone, a cell phone, a tablet device, or a PDA:
(1) Log into their account using the accessing device 30;
(2) Click or tap on a Start parking button which appears on a screen associated with the accessing device 30;
(3) The customer will then be prompted to enter in: a license plate number; a parking zone number; and/or a parking spot number;
(4) A rate will appear on the accessing device 30 for the zone noted;
(5) Using the accessing device 30, the customer will click or tap on a Start Parking Now button which appears on the screen;
(6) The screen will then show an amount that they will be charged when a Stop Parking button is activated, a receipt for the amount, and/or a coded symbol for gaining access to an automated parking facility;
(7) When the customer is ready to leave the parking location, they would click or tap on a Stop Parking Now button on the screen of the access device 30;
(8) A screen would pop-up on the access device 30 to verify confirmation to Stop Parking;
(9) The customer then confirms they are done by clicking or tapping on an appropriate button on the access device 30; and
(10) Depending on the subscriber and parking location, a pay as you go option could result in prompting the user as to when their parking transaction is about to expire and if they would like to add time. This feature helps avoid parking violations.

While there are other pay-by-cell providers, they rely on other ancillary equipment to address the various aspects of the transaction. By having subscribers pre-pay on the system 10, recurring credit card processing fees are avoided. The customer may be charged a convenience fee for using the system 10 and its services.

The system 10 encompasses the entire parking process and protocol and addresses both private and municipal markets. The system allows for full integration across both on-street and off-street parking facilities and related equipment that may be in use.

The system 10 completely integrates a client's parking inventory and facilities. As used herein, the term “client” refers to an owner/operator/municipality. Each facility may be designated a zone number, with the inventory denoted for each parking stall. The system 10 tracks occupancy (purchased parking) as well as transactions purchased with pay by space meters and related equipment. This can be accomplished by transferring data between the meters 44 and the system 10. In turn, the system 10 registers and tracks the transactions in real time. Information about the parking facilities, the parking inventory, the occupancy, and meter transactions can be stored in the inventory database 32.

Due to older antiquated hardware, the interface with the parking facilities and/or the parking meters may warrant the installation of decoders, controllers and/or drivers which would be addressed on a site specific basis. As can be seen, the system 10 has integration flexibility. Space sensor and stall counting technology may be implemented as necessary to integrate where necessary.

The system 10 compiles the data and keeps tracking, logging, and keeping an accurate inventory of parking stalls and other transactions in the inventory database 32. One benefit to the real-time tracking feature of the system is the parking enforcement and violations implementation (parking tickets). By offering the per zone per space reporting, enforcement reports 46 may be offered instantly to officers on patrol via mobile devices, thereby allowing for the expeditious and cost effective implementation of parking violations. The system 10 is also provided with an enforcement app (application) dedicated to the current zones.

The databases 32, 34, 36, and 38 used in connection with the system 10 can be client and customer/user specific and password protected. Each client may have direct access to their respective online transactions, which differs from customer accounts. Each client would be able to view in real-time using an access device 48, such as a desk top browser or a mobile device, and the client interface 18, the following information:

(a) revenue being generated per parking zone;

(b) customer/users of the clients' systems;

(c) per parking space/stall inventory of occupied/purchased spaces and durations;

(d) vehicle license plate specific list for enforcement purposes;

(e) expired spaces for enforcement purposes;

(f) available/unoccupied stalls for inventory management and customer way finding;

(g) history log for documentation purposes;

(h) limited access for enforcement officers in order for real-time field tracking for ticket/violation enforcement;

(i) information provided per stall, per location for field patrolling;

(j) financial tracking on a selected calendar period basis;

(k) ability to increase third party enforcement tracking systems, e.g. license plate recognition (LPR), ticketing systems; and

(l) ticketing features thru a separate enforcement ticket module 50.

The system 10 is designed to system designed to address flexible and variable parking fee rate structures on a per zone, time of day, calendar basis and rates can be revised as needed. The system 10 also provides an ability to allow and track other times of transactions such as events, passes, courtesy cards, etc. using information in the merchant database 38 and the third party interface 22. The system also provides an ability to set-up corporate accounts for various promotions; and an ability to set up merchant accounts in the merchant database 38 for various purchases by the customers through the electronic wallet feature and for allowing validations (credits) to customer accounts.

Bar coded receipts may be provided by the system for each type of mobile transition. The bar coded receipts may be sent to a mobile device 30 for display thereon. The mobile device 30 with the bar coded receipt displayed thereon allows for entry and access through automated parking (gated) facilities and venues where a bar-code reader technology can be employed.

Targeted messaging, promotions and advertising can be implemented to respective customers. This may consist of clients offering the ability for marketing opportunities and paid advertisements from merchants and/or sponsors that may surround and/or be affiliated with a particular parking zone and/or venue.

Transactions and associated funds can be reconciled by the system 10 on a daily, weekly and/or periodic basis between the client and the MPPS. The reconciliation period may be as requested by the specific client, and may include parking and/or other fees collected via the subscribed customers, less any pre-established administrative costs to the MPPS. Also, given the electronic wallet concept, the client is not burdened with significant credit card transaction fees that currently exist due to the methods employed by other pay-by-cell technology.

The system 10 may further include an account identification (ID) interface 68 which would allow the system 10 to authorize accounts. As such, a user ID may show up on a portable device, such as a smart phone, which could be used to allow access to facilities, events, etc. much like a card access.

The system 10 may further include a hardware interface unit 70 which would communicate with devices which allow the system 10 to operate gates, door releases, etc based on account status and approval, i.e. the system is capable of communicating with its own stand-alone hardware.

The system 10 has a number of benefits. Customer advantages to the pay by cell features include the system 10 being App based; location map access by municipality and/or by zone; pay by space and/or license plate; operation on a secure and robust IT platform; variable user fees based on client preferences; pre-pay or pay as you go parking features; notifications to parking patrons in real time; real-time data base with parking patron history; limited transaction/convenience fees; and access to promotion activity based on usage.

Client advantages include: reuse of existing multi-space metering; limited to no capital expenditures based on existing equipment in place; decreased operating costs due to integrated features; maintain complete and concise records of transactions and finances; less cash handling due to enhanced pay by cell features; improved client administration; ability to address multiple parking zones and multiple rates and multiple time intervals; report consolidation for all of the existing parking systems; concise activity data of the parking patrons; enhancement of parking enforcement systems and related violations; limited transaction fees and minimization of credit card fees due to wallet concept; and access to customers (users) for promotional materials, messaging, etc. and the generation of additional revenue through the selling of advertising. Further, one can have an app for enforcement of parking violations.

The system 10 is further advantageous because it has the ability to: (1) offer validation where a user's parking is paid for by a patron (reverse charged) as part of a sale/promotion by using a bar code scan on a mobile device such as a cell phone; (2) prepay parking passes on a monthly/yearly basis utilizing the wallet portion of the system; and (3) write and track tickets/violations.

Other advantages include an ability to establish merchant accounts for validations and purchases to customers via a merchant portal 52; an ability to administer contract passes, payments, etc. by client; and an ability to create account identification codes to allow for integrations to third party system access, transactions, and payments using a payment processor portal 54, a debit card/smart card interface 56, and an advertising interface 58.

While the payment processing system has been described in connection with parking transactions, it may also be used in connection with other types of transactions including but not limited to event/ticket transactions, courtesy cards, and targeted promotional advertising/messaging.

There has been described a mobile payment processing system. While the system has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. A system comprising:
a central host having an inventory database containing information about an inventory of parking spaces;
said central host having an account database containing a plurality of user accounts; and
accessing means for allowing a user to access said inventory database to locate an available parking space and pay for same using his/her user account.

2. The system of claim 1, wherein said accessing means comprises a mobile device.

3. The system of claim 2, wherein said mobile device comprises one of a smartphone, a tablet device, and a PDA.

4. The system of claim 1, wherein said mobile device includes an application for receiving a receipt for said parking space and for displaying a coded symbol for gaining access to an automated parking facility.

5. The system of claim 1, further comprising means for a client to access said central host to receive a periodic report on parking fees collected from said users and means for electronically transferring said collected fees to an account belonging to said client.

6. The system of claim 5, wherein said client access means comprises a client interface for issuing reports to said client and for providing real time information to said client about parking space usage.

7. The system of claim 1, further comprising means for each user to access his/her account so as to add funds to the account and make purchases of goods and services.

8. The system of claim 7, wherein said account access means comprises a browser.

9. The system of claim 1, further comprising said central host having a merchant database containing information about a plurality of merchants and items being offered for sale by said merchants.

10. The system of claim 7, wherein said merchant database contains a plurality of merchant accounts.

11. The system of claim 1, wherein said central host comprises a pre-programmed processor.

12. The system of claim 1, further comprising means for providing law enforcement officials with information about parking violations in real-time.

13. The system of claim 1, further comprising means for sending at least one of messages, advertisements, and promotions to users of the system.

14. The system of claim 1, wherein said accessing means comprises means for allowing a user to prepay for a parking space for a period of time.

15. A process comprising the steps of:
opening a parking app on an accessing device;
pushing a start parking button on said parking app;
pushing a start parking now button when a parking location has been located;
showing an amount that will be charged on a screen on said accessing device; and
pushing a stop parking now button on said accessing device when the parking location is to be left.

16. The process of claim 15, further comprising entering information comprising at least one of a license plate number, a parking zone number, and a parking spot number using said accessing device after pushing said start parking button.

17. The process of claim 16, further comprising displaying a rate on said accessing device after entering said information.

18. The process of claim 15, further comprising verifying a stop parking instruction.

19. The process of claim 15, further comprising debiting a user account with said amount that will be charged.

20. The process of claim 15, further comprising prompting a user as to when a parking transaction is about to expire and inquiring whether the user would like to add time to the parking transaction.
